(19) United States
(12) Patent Application Publication
(10) Pub. No.: US 2026/0036380 A1
(43) Pub. Date: Feb. 5, 2026

(54) THERMAL MANAGEMENT SYSTEM USING FORCED AIRFLOW

(71) Applicant: Guy Leath Gettle, Alamo, CA (US)

(72) Inventor: Guy Leath Gettle, Alamo, CA (US)

(21) Appl. No.: 19/101,230

(22) PCT Filed: Aug. 16, 2023
(86) PCT No.: PCT/US2023/072321

§ 371 Date: Feb. 4, 2025

Related U.S. Application Data
(60) Provisional application No. 63/371,639, filed on Aug. 16, 2022.

(51) Int. Cl. F28D 20/02; F28D 21/00; H01M 10/613; H01M 10/627; H01M 10/6563; H01M 10/659

(52) U.S. Cl. CPC F28D 20/023; H01M 10/613; H01M 10/627; H01M 10/6563; H01M 10/659; F28D 2021/0028; F28D 2021/0042; H01M 2220/10

(57) ABSTRACT

Means for maintaining temperatures of lithium-containing electrochemical cells, inside electronic devices, and within containers within the desired temperature range without requiring the use of cooling liquids. Temperature is maintained through the use of coatings and at least one fan. The coating features at least 30% particles consisting of encapsulated solid substances that change phase at temperatures between 25 and 45 degrees Celsius. By means of the present invention, thermal management of lithium-containing electrochemical cells, within enclosures, inside structures and inside containers can be provided with recyclable coatings.

### RELATION TO OTHER PATENT APPLICATION(S)

This patent application claims the benefit of commonly owned U.S. provisional patent application Ser. No. 63/31,639, filed on Aug. 16, 2022 in the name of Guy L. Gettle. Where permitted by law, the entire contents of this provisional patent application are hereby incorporated by reference.

### STATEMENT REGARDING U.S. FEDERAL GOVERNMENT SUPPORT

None.

### TECHNICAL FIELD

This invention relates to systems that are used to regulate temperatures of surfaces within specific limits, and specifically to systems regulating temperatures of surfaces within substantially enclosed spaces with cyclic or sustained internal heat generation.

### BACKGROUND ART

Enclosures are available in many forms, including housings for electronic equipment, cases for battery packs, and passenger compartments of vehicles. Interior spaces within a wide range of enclosures are often desirably kept within a temperature range that is tolerable to humans, which is roughly between 15 and 35 degrees Celsius. Rooms inside structures are substantially enclosed spaces.

Temperatures exceeding this range cause problems for many materials and living things. When temperatures around refrigeration equipment rise above human-tolerable levels, they become unable to maintain acceptable conditions inside spaces intended to remain cool. Lithium-containing batteries cannot be recharged to their full rated capacity and generally experience shorter useful lives. Pharmaceuticals, foodstuffs, adhesives, wines and perfumes may be ruined, animals being shipped or sheltered may die from elevated temperatures.

Air conditioning equipment is widely used to maintain desired temperatures. The energy to power the equipment, additional space needed to accommodate the equipment, and hardware for system components make air conditioning expensive, however. At best, chemical storage and enclosures for electronic devices such as computers, communication equipment, and microwave ovens lack space for air conditioning and can only incorporate fans for convective cooling by airflow.

The introduction of electric vehicles (“EVs”), with battery enclosures largely filled with lithium-containing batteries, has created immense demand for maintaining temperatures between 25 and 45 degrees Celsius in densely-packed spaces. Virtually all lithium-containing batteries available currently must be kept at human-tolerable temperatures. When cells operate above forty-five degrees Celsius (45 C), their usable service life is shortened considerably. Such temperatures are easily reached during fast charging and high power demand.

Above roughly 150 C, a series of irreversible chemical decomposition reactions that is generally called “thermal runaway” begins in liquid electrolytes. Thermal runaway ultimately results in violent venting of flaming electrolyte, ejection of molten electrode components, and generation of large volumes of flammable gases.

Electric vehicles require hundreds of lithium-containing cells installed in battery packs. Not only must these cells be kept at human-tolerable temperatures, temperature differences between these hundreds of cells must be kept within a few degrees Celsius of one another as large gradients also lead to early cell breakdown.

Power demand is very high during certain phases of lithium-containing battery operation. Providing adequate power requires high cell discharge rates and high electrical currents, both of which generate intense heat. Because of this, cooling systems must be employed. If large spaces are available, cells can be separated and more free-air volume inside battery pack enclosures would create better convective airflow conditions. This space, however, is not available in many applications such as inside EV passenger cars, communications equipment, or beamed weapon systems. For cost and space reasons, there is relentless demand for higher energy density, meaning more kilowatt-hours of energy storage in the smallest possible volume.

With the current art, EV engineers use liquid cooling to handle the heat generated during rapid charge and discharge modes. Liquid cooling systems use flow channels in cooling plates, cooling fluids, and radiators not significantly different than used for internal combustion engines. A recent model of the Audi 3 e-Tron, as one example, has 4 heat exchangers interleaved with battery pack and base end of cells. Verma et al (2019) pointed out that the Tesla Model S at the time of their research used serpentine cooling pipes with water-glycol as coolant.

Long cooling channels introduce big pressure drops that become greater when flow rate increases. This increases energy demand for pumping. Yet even with liquid cooling, heat generated during abuse conditions can exceed safe levels. Cooling systems are presently the greatest source of parasitic energy drain from EV battery packs.

Air cooling would be ideal but its convective heat transfer properties cannot provide adequate cooling with practical airflow rates. When ambient air temperatures exceed 50 C, convective air cooling at any flow rate cannot keep lithium-containing cells within human-tolerable conditions.

The need for improved means of keeping ambient temperatures below 50 C is thus common to EVs and electric aircraft, battery-powered energy storage systems, buildings, electronic devices, refrigerators, air conditioning systems and many other applications. Failure to cool adequately causes problems ranging from equipment failure to violent fires. Cooling means allowed by the present art, such as those involving pumps, compressors, and conduits for cooling fluids impose serious cost and volume burdens.

Removing Heat Energy from Hot Devices and Systems

Regardless of the states of matter, heat energy can be transferred from a material at one temperature to another at a different temperature by conduction, radiation, convection or a combination of any of these. Conduction can be changed by changing materials or arrangements of materials. Convection is more involved, as it is a process involving three steps, but this gives engineers many more design possibilities to optimize.

The first step is conduction of heat to the surface of the material where it is in contact with a fluid. The second step is conduction of heat energy from the material surface into the fluid. The third step is mass transport, in which the fluid having received heat energy moves away, taking the added heat energy with it.

The second step, conduction of heat energy from a solid surface to a fluid, depends upon the properties of both solid surface and the fluid at their interface. For the solid surface, properties are combined in what is generally call the convective heat transfer coefficient, often designated by the letter h in English-language technical literature. The convective heat transfer coefficient is a characteristic of the solid material, although surface cleanliness, roughness and profiles such as dimpled or corrugated affect it. For the fluid, important properties are its velocity, degree of turbulence, heat capacity and density. When the fluid is not moving, only natural convection caused by density and temperature differences within the fluid can occur.

Increasing values of convective heat transfer coefficients is crucial for improving the performance of electronic equipment, lithium-containing cells and battery packs, air conditioning as well as reducing energy demand for these systems. Yet changing parameters significant to convective heat transfer coefficients with the present art are constrained. Fluid velocity is limited by motive force and flow restrictions, which also affect the degree of turbulence. For ambient conditions tolerable to humans, fluid density changes are limited by temperature, particularly for air. At atmospheric pressure and temperatures between 10 and 50 degrees Celsius, the ranges of heat capacity and density for water, air and refrigerants are very small, thus manipulation of these parameters cannot make significant improvements.

For solid materials having similar surface profiles, the convective heat transfer coefficient varies most with fluid velocity. Thus technical literature often provides separate values of h for natural and for forced convection, forced meaning that the fluid is moved by mechanical means such as pumps and fans.

Aluminum has a high convective heat transfer coefficient range, being greater than 200 watts per square meter per degree Celsius. Graphitic materials, boron nitride, and silicon carbide have comparatively high coefficients, in the range of 150 to 200 W/m²-C. Other metals, such as tin, bismuth, and lead, have low convective heat transfer coefficients. Steel and copper alloys have coefficients between those of bismuth and graphitic materials.

Gaseous air fills and at least partially surrounds occupied structures, ships, and vehicles, as well as places where most electronic devices are present. Air has a very low heat transfer coefficient. The mass of air within battery packs and electronic devices is also low, thus only small amounts of heat energy can be absorbed by air at atmospheric pressure. Natural convection, in which heat energy is transferred by unforced movements of air, can therefore only provide adequate cooling for small electronic devices. EV battery packs, large communication equipment, computers and microwave ovens require forced convection, meaning the use of powered fans or refrigeration systems.

As Han et al stated, cooling of EV battery packs would ideally be achieved with air as the cooling fluid. This would avoid potential leaks, eventual cooling channel clogging problems, high parasitic energy drain needed to power pumps, and avoid having to provide large spaces to accommodate radiators and mechanical components. However, the airflow rates necessary for air cooling allowed by the present art are unacceptably high as they would generate intolerable noise. Obstructions within battery pack enclosures interfere with airflow, leading to unacceptably large temperature gradients between cells.

With the present art, EVs, E-aircraft, and other electronic equipment that handle kilowatt levels of power (kilojoules per second) require liquid cooling. Much smaller cooling systems can meet demands by using combining new and novel coatings in combination with forced air flow.

### Passive Means for Cooling

Coatings with heavy loadings of encapsulated phase change materials (“PCMs”) can absorb large amounts of heat energy through changes of phase. Heat transfer into or out from PCMs can occur by means of conduction, convection, or a combination of these processes. Once that heat has been removed and temperature drops below the fusion temperature for that PCM, the PCM re-solidifies and then is ready to absorb more heat energy.

Heat absorption and rejection in PCMs occur at or within a narrow range around a specific temperature characteristic for the particular substance. The heat energy transferred is generally referred to as “latent heat” or as a change of enthalpy. The term enthalpy of fusion applies to a phase change from solid to liquid, enthalpy of decomposition if the compound breaks apart, and enthalpy of vaporization if the phase change is from liquid to a gas. Many solid PCMs exist that melt between 20 and 50 C while absorbing more than 100 kilojoules of heat energy per kilogram during the transition.

Use of PCMs for lithium-containing cells and battery packs packed with them has been studied by a significant number of researchers since 2002, particularly in regard to EVs. Heat generated by batteries during use is absorbed in the PCMs, helping to regulate temperatures while allowing for convective airflow. With sufficient masses of PCMs, adequate cooling of lithium-containing battery packs for as long as 1 hour have been achieved, such as demonstrated by Javani et al (2014) and described in more detail in Dincer et al (2017).

Helpful effects of using PCMs for cooling and thermal management of lithium-containing cells have been proven by a significant number of researchers since 2002. Examples include Verma et al (2019), who studied different thicknesses of fatty acid PCMs surrounding lithium-containing pouch cells. Javani et al studied the use of paraffinic wax separators between lithium-containing pouch cells, including the effect of different PCM thickness. Ramandi et al (2011) evaluated the use of an encapsulated paraffinic PCM, comparing a jacket containing one PCM with cooling obtained with one jacket enclosed another, each with a PCM having a different melting temperature. Kaul obtained a patent (U.S. Pat. No. 6,939,610) for coatings comprised of microencapsulated PCMs in thermosetting resins that were developed to protect Space Shuttle components. All of these researchers showed that temperatures in the heat-generating cells could be kept at relatively constant levels as long as solid PCM material remained.

Unfortunately, neither fusible inorganic salt, fatty acid, nor paraffinic wax PCMs possess good thermal conductivity properties. Despite their excellent energy absorption properties, heat energy from hot regions diffuses slowly inside these PCMs. When surrounding components generating heat, PCMs trap heat in the nature of insulations, delaying transfer of heat energy to surroundings.

To get around these problems, a number of researchers have evaluated fibrous, mesh, and open-celled foam materials having high thermal conductivities filled with PCMs. Chen et al (2020) studied the use of PCM-infused graphitic foams with air cooling for hybrid EV battery packs. Greco et al (2015) showed that thermal conductivity outward from lithium-containing cells is increased by using PCM-infused graphitic foams, whereas normally radial thermal conductivity is much lower than along the surface of the cell. One company, AllCell Technologies LLC of Broadview, Illinois has developed and commercialized products using this concept, including forms that hold and separate batteries in arrays.

### BACKGROUND ART REFERENCES

Chen, F, Huang, R, Wang, C, Yu, X, et al: Air and PCM cooling for thermal management considering battery cycle life; Applied Thermal Engineering 173 (2020): 115154
Dincer, I, Hamut, H S & Javani, N; Thermal Management of Electric Vehicle Battery Systems; John Wiley & Sons Ltd, 2017
Greco, A, Jiang, X & Cao, D; An investigation of lithium-ion battery thermal management using paraffin/porous graphite-matrix composite; J Power Sources 278 (2015): 50-68
Han, T, Khaligi, B, Yen, E C & Kaushik, S; Li-ion battery pack thermal management: liquid versus air cooling; J Thermal Science & Engineering Applications 11:021009 (April 2019)
Javani, N, Dincer, I, Naterer, G F & Rohrauer, G L; Modeling of passive thermal management for electric vehicle battery packs with PCM between cells; Applied Thermal Engineering 73 (2014): 307-316
Kaul, R K; U.S. Pat. No. 6,939,610; Issue date Sep. 6, 2005
Ramandi, M, Dincer, I & Naterer, G F; Heat transfer and thermal management of electric vehicle batteries with phase change materials; Heat Mass Transfer 47 (2011): 777-788
Verma, A, Shashidhara, S & Rakshir, D; A comparative study on battery thermal management using phase material (PCM); Thermal Science & Engineering Progress 11 (2019): 74-83
Xie, Y, Tang, J, Shi, S et al; Experimental and numerical investigation on integrated thermal management for lithium-ion battery pack with composite phase change materials; Energy Conversion & Management 154 (2017): 562-575

### LIMITATIONS OF THE PRESENT ART

As Han et al pointed out, adequate cooling of EV battery packs by air alone is not possible with the current art. The convective heat transfer coefficients for air flow over steel, stainless steel, aluminum, and copper are too low at the maximum practical mass flow in cooling systems. The same holds true when these materials are used to confine PCMs in order to prevent molten PCMs from dripping on other components.

Without novel means of increasing convective heat transfer to preferable surroundings, efforts to reduce the size of lithium-containing battery packs, electronic devices, refrigeration equipment and air conditioning are constrained.

### DISCLOSURE OF THE INVENTION

The desirable absorption of substantial heat energy by PCMs can be achieved more efficiently and effectively if thin coatings containing encapsulated PCM powder particles are applied to enclosures for electronic equipment and lithium-containing electrochemical cells, ducts in air conditioning systems, interior surfaces inside buildings, fans, and heat exchanger surfaces such as fins and cooling plates. Much greater amounts of heat energy can be removed from enclosures by adding forced air convection using at least one fan in combination with enhanced convective heat transfer coatings that incorporate phased change materials (“PCMs”).

Unlike thick PCM layers or PCM-filled metal foams, heat transfer in thin coatings occurs rapidly.

Even faster heat transfer rates are achieved through use of encapsulated PCMs that also have characteristic dimensions less than 100 microns. Such materials are generally called microencapsulated PCMs. Microencapsulated PCMs are commercially available at present. These particles are bound within the continuous resin matrix when dispersed therewithin, thus melted PCMs cannot leak into the coating matrix.

Heat transfer rates are substantially increased in thin coatings by dispersions of graphitic powders having characteristic dimensions less than 100 microns or micrometers. When powders having high thermal conductivities such as graphite and boron nitride are dispersed in coatings, the path between encapsulated PCMs having low thermal conductivity and small particles having high thermal conductivity is short. The path to the surface is also short, since coating thicknesses are less than one millimeter. In one millimeter there can be 20 to 50 particles of encapsulated PCMs and particles having high thermal conductivity materials, or average spacings of 10 to 25 microns between particles.

Mass flow of air must remove the latent heat stored within the PCMs. When heat generation is low, only some of the PCM mass will melt, or melt only that PCM having the lowest fusion temperature when 2 or more PCMs are present. For cyclic, sustained, and intense heat generation within the enclosure, the latent heat must be extracted often.

This entails matching the mass flow of air needed to reduce PCM temperatures below their fusion temperature frequently to heat generation within enclosures. Frequent PCM melt/re-solidification/melt events absorb substantial amounts of heat through fusion enthalpy which is then removed by convection.

PCM fusion temperatures are preferably between 25 and 45 degrees Celsius. When two or more encapsulated PCMs each having different fusion enthalpies are present in the coating, heat is released from the PCM melting at the lowest temperature which helps melt the PCM having a higher fusion temperature. This mechanism further accelerates and enhances latent heat absorption.

For battery packs filled with numerous lithium-containing electrochemical cells, maintaining uniform cell temperatures is crucial. Cell temperatures should not vary more than 2 degrees Celsius. Achieving temperature uniformity is quite difficult when free air volume is constrained, narrow flow channels and numerous obstructions are present, and fan-to-cell distances vary considerably.

In these cases the presence of at least one additional fan is preferable. The second fan should serve as an exhaust fan, disposed in such a manner that it accelerates mass air flow from the enclosure to the surroundings.

More cooling surface with microencapsulated PCM-loaded coatings can be achieved with additional components such as separators between heat-generating electrochemical cells, fins, and circuit boards substantially comprised of microencapsulated PCM-loaded coatings made rigid with a glass fiber textile. Such rigid components as circuit boards and separators placed between lithium-containing electrochemical cells would not include graphite particles. Heat transfer would instead by enhanced by using other high thermal conductivity powder particles that are electrically non-conductive. These components would have functions in addition to adding more surface for thermal management, such as directing airflow and blocking heat transfer between other components.

Thermal management engineers often use the concept of “Q_{ITD}”, mathematically defined as

$${Q}_{ITD} = {Q}_{g e n e r a t e d} / ( {T}_{e x i t} - {T}_{inlet} )$$

The objective is to maximize Q_{ITD}, which can be accomplished by reducing the difference between inlet and exhaust air temperatures. When used as an exhaust fan, the second fan in combination with the latent heat absorption of Q_{generated} minimizes temperature gradients among the cells.

With convection cooling, the lowest temperature possible for the surfaces being cooled is that of the inlet air, or Tᵢₙₗₑₜ. When the ambient temperature is higher than the PCM fusion temperature, convection cannot re-solidify the PCM. This situation arises when lithium-containing battery packs under EVs are parked on hot pavement or are present in hot climates. These situations require means of cooling the inlet air. The same need for cooling hot inlet air applies to battery energy storage systems, radars, and beamed weapons systems.

Cooling inlet air can be accomplished by the employment of fusible metals enclosed in thin aluminum cases. The fusible metal-filled cases are placed within lithium-containing battery packs, electronic equipment enclosures, and other enclosed spaces such as inside mobile homes.

Fusible metals are alloys typically comprised of combinations of bismuth, tin, lead, silver or cadmium. Many of these, such as Wood's metal, Cerrobend, Field's metal and Rose's metal, have fusion temperatures in the preferable range between 50 and 90 degrees Celsius. There are many fusible metal alloys available commercially with fusion temperatures ranging from below 0 degrees Celsius to 100 degrees Celsius. The present invention gives engineers considerable flexibility in thermal management system design.

Cooling inlet air is also possible by applying thin PCM-containing coatings to surfaces of open cell foams comprising aluminum, copper or graphite. When placed inside enclosures between enclosure walls and electronic components, the coated metallic or graphitic foam blocks heat from hot surfaces and external hot air. These coated foams can replace or augment the use of fusible metals encased in aluminum.

### SUMMARY OF THE INVENTION

In view of the shortcomings of existing means of regulating temperatures between 25 and 45 degrees Celsius for lithium-containing electrochemical cells, inside electronic devices, and within containers, novel means are required. The present invention accordingly offers a means for maintaining temperatures within the desired temperature range without requiring the use of cooling liquids through the use of coatings and at least one fan. By means of the present invention, thermal management of lithium-containing electrochemical cells, within enclosures, inside structures and inside containers can be provided with recyclable coatings.

### BRIEF DESCRIPTION OF THE DRAWINGS

FIG. 1 depicts the basic embodiment of the thermal management system for an enclosure.

FIG. 2 illustrates another embodiment in which a second fan is disposed on an enclosure surface different than that of the first fan.

### REFERENCE NUMERALS IN DRAWINGS

10 enclosure
20 coating with encapsulated phase change material particles
30 fan, or first fan
32 opening for fan
34 surface on/into which is mounted first fan
36 vent
40 second fan
42 opening for second fan
44 surface on/into which is mounted second fan
50 lithium-containing electrochemical cell
60 second coating with different encapsulated phase change materials and high thermal conductivity powder particles
70 open-cell aluminum foam
80 separator

### DETAILED DESCRIPTION OF EMBODIMENTS OF THE INVENTION

The various drawing figures accordingly depict a number of embodiments according to the present invention. Those embodiments are summarized below followed by a more detailed description of the respective figures.

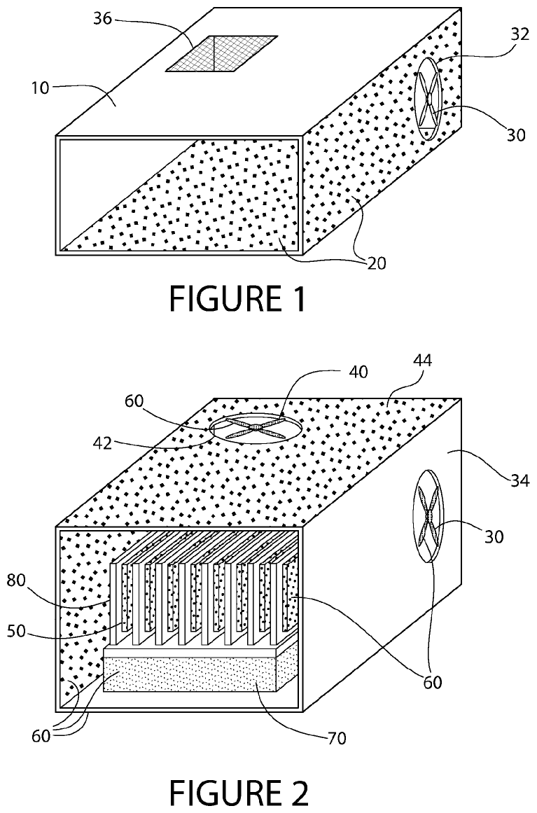

FIG. 1 shows a basic embodiment of the thermal management system using forced airflow. The enclosure 10 that has a coating 20 with encapsulated phase change material particles applied to its interior and exterior surfaces. A fan 30 is mounted proximate to an opening 32 that admits inlet air. At least one vent 36 allows heated air to escape to the surroundings.

FIG. 2 is a cross section that depicts another embodiment in which a second fan 40 is mounted proximate to an opening 42 for the second fan in a surface 44 different from that 34 for the first fan 30. Lithium-containing electrochemical cells 50 are contained within the enclosure. A second coating with different encapsulated phase change materials and high thermal conductivity particles 60 is applied to the fans, an open-cell aluminum foam 70, separators 80, and inner surfaces of the enclosure.

### Operation

The thermal management system with forced airflow becomes operable when the first fan draws inlet air inside the enclosure. Heat generated by electronic devices or lithium-containing electrochemical cells within in the enclosure cause encapsulated phase change materials in the coating to melt. Melting of the phase change materials causes substantial amounts of heat energy to be absorbed by the phase change materials in the form of latent heat. Air moving over the coated surfaces absorbs the latent heat and transports it by means of convection through vents to the surroundings.

In one embodiment, the fan for generating air flow within the enclosure, is attached to a surface of the enclosure, said fan defining a fan surface, wherein rotation of said fan sweeps out an area of said fan, and the fan itself has a surface, upon which the coating(s) may be applied. The opening in the wall of the enclosure may be located within 2 centimeters of the nearest surface of the fan, and may have an area that is at least 50% of the area of the fan.

In another embodiment, the thermal management system may include a mechanical system such as an air conditioner, heat pump, and water spray is disposed within four meters of the opening for the fan.

In another embodiment, the coating is applied to at least one surface of at least one component that increases convective heat transfer. Exemplary such components include fan blades, tubes, fins, metal mesh, honeycombs, and grilles.

A second fan mounted on a surface of the enclosure different than that to which the first fan is mounted accelerates air from inside the enclosure to the surroundings. The mass of the phase change materials within the coating and the mass flow and velocity of air forced to move through the enclosure are chosen to extract substantially all of the latent heat absorbed by the phase change materials by means of convection at a rate that equals or exceeds the rate at which heat is generated by electronic devices or lithium-containing electrochemical cells within in the enclosure.

When two encapsulated phase change materials each having a fusion temperature that differs from that of the other by at least 10 degrees Celsius are incorporated in the coatings, the latent heat released by the phase change material having a lower fusion temperature helps to accelerate melting of the other phase change material. This accelerates heat extraction. The addition of high thermal conductivity powder particles having a thermal conductivity coefficient at least 250 watts per meter-Kelvin (250 W/m-K) accelerates heat transfer still further. The combination of faster extraction of latent heat and enhanced thermal conductivity of the coating greatly increases the convective heat transfer coefficient of the coating. Increased latent heat storage, increased convection of that heat by means of enhanced convective heat transfer coefficients, and forced air movement having sufficient velocity and mass flow to transport convected heat energy to the surroundings produces a thermal management system that is more efficient and effective than any available through the current art.

Phase change materials are selected that have fusion temperatures just above the lowest temperature of the preferred substrate operating temperature. One would select a PCM with a fusion temperature of 30 degrees Celsius if the preferred continuous substrate temperature is 25 degrees Celsius. If operation of the electronic device or lithium-containing electrochemical cells inside the enclosure is expected to vary, then coatings having more than one PCM with different fusion temperatures should be used.

Coatings containing graphitic or powdered activated carbon particles are preferred. However, graphitic and powdered activated carbon particles should not be used in coatings applied directly to electronic devices or lithium-containing electrochemical cells. This is to avoid potential electrical current flow to develop within the coating or pass through the coating to other components. Heat transfer would instead by enhanced by using other high thermal conductivity powder particles that are electrically non-conductive.

The use of open cell aluminum foam components such as separators and plates will enhance heat absorption from the surroundings external to the enclosure. Open cell foam expands the cooling surface by orders of magnitude. It also changes natural convection airflow within the enclosed space. Use of thin PCM-containing coatings on these surfaces will enhance natural convection airflow by creating numerous eddies. Such local temperature gradients can also re-solidify a significant portion of melted PCM substances, thus enabling them to re-melt and absorb more latent heat.

Yet another means of cooling inlet air is to employing filter components having thin PCM-containing coatings applied to them. Such coated filters would be mounted immediately downstream of inlet fans and immediately upstream of exhaust fans. The PCM-containing coatings could usefully employ a single PCM substance or more than one. Should more than one PCM substance be included, the fusion temperatures of each should vary at least 10 degrees Celsius from the others. Paper, glass and metallic filter components are all acceptable embodiments.

The thermal management system using forced airflow can be used quite effectively to provide “peak shaving” that limit maximum temperatures within the enclosed space. This system can also be used to create large thermal gradients by either coating only some surfaces, and by using different PCMs in coatings applied to different surfaces or components. Coating both interior and exterior surfaces of the enclosure walls and coating fan blades will provide even more efficient and effective thermal management.

Devices that generate heat may be placed within the enclosed space so that their heat output may be managed, e.g., thermal management. Such devices to be thermally protected include a motor, an electrochemical cell that stores energy, a computer, a communications device, an electronic measuring and monitoring device, and an electrical transformer, for example.

The thermal management system furthermore may be configured to be used for enclosing foodstuffs such as fruits, vegetables, meats, yoghurts and cheeses, for example.

### Advantages

The invention offers numerous alternatives for a person skilled in the art of designing heat transfer and thermal management systems, and safety for equipment that generates internal heat. The invention also can greatly improve safe storage and handling of energetic materials such as explosives and propellants.

The advantages of the present invention over any means available in the present art for a specified weight and a specified thickness are considerable. All embodiments would make possible

New materials and fabrication processes may be developed in the future that could further enhance capabilities within embodiments discussed elsewhere.

### CONCLUSION, RAMIFICATIONS AND SCOPE

Accordingly, the reader will observe that coatings containing encapsulated phase change materials applied to lithium-containing battery cells, electronic device enclosure surfaces, and cooling systems that use air as the cooling medium would offer substantial protection of cells and batteries containing lithium from of fire, prevent thermal runaway conditions from developing internally due to combustion of any one cell or battery, and protect surroundings from heat and smoke generated by fires inside the container. The present invention makes this possible for almost any imaginable cell or battery size or configuration.

What is claimed is:

1. A system for maintaining temperatures within an enclosed space, comprising:
an enclosure defining said enclosed space, said enclosure having at least one wall and an internal surface area;
at least one coating applied to at least 50% of the internal surface area of said enclosure, said at least one coating including at least 30% particles of encapsulated solid substances that change phase at temperatures between 25 and 45 degrees Celsius;
at least one fan for generating air flow within the enclosure, said fan being attached to a surface of the enclosure, said fan defining a fan surface, wherein rotation of said fan sweeps out an area of said fan, and
an opening in the wall of the enclosure within 2 centimeters of the nearest surface of the at least one fan, said opening having an area at least 50% of the area of the at least one fan.

2. The system of claim 1, in which said at least one coating is applied to at least 50% of the surface areas of at least one electrochemical cell that contains lithium when said at least one electrochemical cell that contains lithium is disposed within the enclosure.

3. The system of claim 1, in which at least one device that generates heat during operation is disposed within the enclosure, said at least one device being selected from the group consisting of a motor, an electrochemical cell that stores energy, a computer, a communications device, an electronic measuring and monitoring device, and an electrical transformer.

4. The system of claim 1, configured to be used for enclosing foodstuffs selected from the group consisting of fruits, vegetables, meats, yoghurts and cheeses.

5. The system of claim 1, wherein said fan is an air inlet fan, said system further comprising a filter component having thin PCM-containing coatings covering at least 50% of its surface, said filter component being disposed immediately downstream of said air inlet fan.

6. The system of claim 1, further comprising (i) a second fan having a surface, and (ii) a second opening in the wall of the enclosure within two centimeters of the nearest surface of said second fan, said second fan being disposed such that it draws air from the enclosure and expels the air to the surroundings by means of said second opening.

7. The system of claim 1, in which said at least one coating is applied to at least one surface of at least one component that increases convective heat transfer, said at least one component selected from the group consisting of a fan blade, tube, fin, metal mesh, honeycomb, and grille.

8. The system of claim 2, further comprising a second coating comprising at least 30% particles consisting of encapsulated solid substances that change phase at temperatures between 25 and 45 degrees Celsius, wherein said second coating is applied to at least one other coating comprising at least 30% particles consisting of encapsulated solid substances that change phase at temperatures between 25 and 45 degrees Celsius, said second coating having a temperature at which the encapsulated solid substances changes phase that differs by at least 10 degrees Celsius from the temperatures at which other encapsulated solid substances change phase.

9. The system of claim 2, further comprising a mechanical system selected from the group consisting of air conditioner, heat pump, and water spray is disposed within four meters of said opening for said at least one fan.

10. The system of claim 2, wherein said at least one fan is an air inlet fan, said system further comprising a filter component having thin PCM-containing coatings covering at least 50% of its surface, said filter component being disposed immediately downstream of said at least one air inlet fan.

11. The system of claim 2, further comprising rigid components including separators, wherein said separators are placed between electrochemical cells that contain lithium, heat exchangers, electronic circuit boards, and fan blades, said separators substantially featuring glass fiber textile infused with said coating or a second coating, said coating or second coating having at least 30% particles consisting of encapsulated solid substances that change phase at temperatures between 25 and 45 degrees Celsius.

12. The system of claim 2, in which a second coating comprising at least 30% particles consisting of encapsulated solid substances that change phase at temperatures between 25 and 45 degrees Celsius is applied to at least one other coating comprising at least 30% particles consisting of encapsulated solid substances that change phase at temperatures between 25 and 45 degrees Celsius, said second coating having a temperature at which the encapsulated solid substances changes phase that differs at least 10 degrees Celsius from the temperatures at which other encapsulated solid substances change phase.

13. The system of claim 8, wherein said at least one coating or second coating is applied to the surfaces of components that increase convective heat transfer, said components selected from the group consisting of fan blades, tubes, fins, metal mesh, honeycombs, and grilles.
